(19) United States
(12) Patent Application Publication
(10) Pub. No.: US 2016/0342947 A1
(43) Pub. Date: Nov. 24, 2016

(54) SYSTEM AND METHOD FOR HUMAN RESOURCE MANAGEMENT

(71) Applicant: MANIKANTH DORNADULA, BENGALURU (IN)

(72) Inventor: MANIKANTH DORNADULA, BENGALURU (IN)

(21) Appl. No.: 14/754,736

(22) Filed: Jun. 30, 2015

(30) Foreign Application Priority Data
May 18, 2015 (IN) 2481/CHE/2015
Jun. 24, 2015 (IB) PCT/IB2015/054729

(51) Int. Cl. G06Q 10/10

(52) U.S. Cl. CPC G06Q 10/1053

(57) ABSTRACT

The present invention provides a system and method for hiring non-utilized candidates of HRP organizations who are available for short term projects of the EMP organizations and also the matching the skills of the candidates with the job posting entered by EMP organizations, in which resource team of the HRP organization can enter and update the candidates profile including their skill and availability in the system and the EMP organization can view, sort, search, display the candidates profile. The EMP organization can send the interview schedules for different round to the candidates. The HRP organization receives the details of interview schedule, and manages & monitor within the system. The system does not allow disclosing the personal & employment details of the candidate to the EMP organization. Moreover, the candidate can be deployed with the EMP organization as a short term employee, once the EMP organization confirms the candidates.

### FIELD OF INVENTION

The embodiments herein generally relate to human resource management. More specifically, the embodiments described herein relate to a system and method for human resource management. Particularly, relates to a system and method for utilizing the non-utilized human resource of at least one organization to the human resource requirement's organizations.

### BACKGROUND OF THE INVENTION

Human resource [HR] management is a function in organizations designed to maximize employee performance of an employer's strategic objectives. HR is primarily concerned with the management of people within organizations, focusing on policies and systems. HR departments and units in organizations typically undertake a number of activities, including employee recruitment, training and development, performance appraisal, and rewarding (e.g., managing pay and benefit systems). The definition of HRM is that it is the process of managing people in organizations in a structured and thorough manner.

In organizations, particularly in IT industry, on the “bench” refers to the time that you are in-between projects. Therefore, there are times where there might not be any work between projects may be referred to as “on the bench” or “unutilized human resource”. Similarly, the bench strength refers to the competence and number of employees ready to fill vacant leadership and other position. A bench, up to a point, is a necessary evil. In normal times, IT companies have about 20% of their employee base on the bench. Bench strength is essential for a growing company. It helps company to staff a new project quickly without waiting for recruitment. On the other hand, benches are considered a cost to the company. Hence bench becomes one of the most uncomfortable places to be in.

Therefore, there is a need in prior art to develop a system and method for human resource management to not only overcome the problem associated with the prior art but also to provide a platform to connect the employer organization and human resource pool of human resource provider organization in order utilize the non-utilized human resource of at least one organization to the employers' organizations.

### OBJECTS OF THE INVENTION

Some of the objects of the present disclosure are described herein below:

A main object of the present invention is to provide a system and method for human resource management.

Another object of the present invention is to provide a system and method for registering and connecting the employer organization and human resource pool of human resource provider organizations.

Yet another object of the present invention is to provide a system and method for utilizing the non-utilized human resource of at least one organization to the human resource requirement's organizations.

Still another object of the present invention is to provide a system and method for engaging non-utilized human resource of the human resource requirement's organizations in short term external projects of the employers organizations.

Another object of the present invention is to provide a system and method for finding the short term human resource of a particular skill to fulfill the project need of the human resource requirement's organizations.

Another object of the present invention is to provide a resource engine to match the skills of the non-utilized human resource with the requirements provided by the employer's organizations.

Another object of the present invention is to provide a system and method to allow the non-utilized human resource to go through the process internal recruitment and send interview schedules for different rounds to the candidates/human resource of the human resource provider organizations.

The other objects and advantages of the present invention will be apparent from the following description when read in conjunction with the accompanying drawings which are incorporated for illustration of preferred embodiments of the present invention and are not intended to limit the scope thereof.

### SUMMARY OF THE INVENTION

In view of the foregoing, an embodiment herein provides a system and method for human resource management, wherein the system and method can be utilized for hiring non-utilized human resources [herein referred as candidates] of human resource provider [herein referred as HRP] organizations who are available for short term projects of the employer's organizations [herein referred as EMP organizations] and also the matching the skills of the candidates with the project requirement [herein referred as job posting] entered by employer's organizations, in which resource team of the HRP organization can enter and update the candidates profile including their skill and availability (from & period) in the system and the employer organization can view, sort, search, display the candidates profile based on the candidates profile parameters. The system and method for human resource management can be utilized to allow the EMP organization to send the interview schedules for different round to the candidates of HRP organization. Further, the system and method can be utilized for receiving the details of interview schedule by HRP organization, and manage & monitor within the system. In addition, the system and method do not allow disclosing the personal & employment details of the candidate to the EMP organization. Moreover, the system and method allows the candidate to deploy with the EMP organization as a short term employee or contract employee, once the EMP organization confirms the candidate after the whole internal recruitment process. Further, the HRP organization can manage the calendar of the candidates outsourced using the system.

According to an embodiment, the human resource management system may include a server, a database, a network, an interface device, and a resource engine, wherein the resource engine may include several components that may be configured to perform various operations. Accordingly, the recruitment engine can include a registration module, a login module, a resource pool module, a job post module, a matching module, an internal recruitment module, a deployment module, a calendar module, a confidential module, and other modules.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures the use of the same reference numbers in different figures indicates similar or identical items.

FIG. 1 illustrates a sample network environment for implementing system and method of human resource management, according to an embodiment therein;

FIG. 2 illustrates a schematic diagram of resource engine of the human resource management system, according to an embodiment therein;

FIG. 3 illustrates role of EMP organization in the human resource management system and method, according to an embodiment therein; and

FIG. 4 illustrates role of HRP organization in the human resource management system and method, according to an embodiment therein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

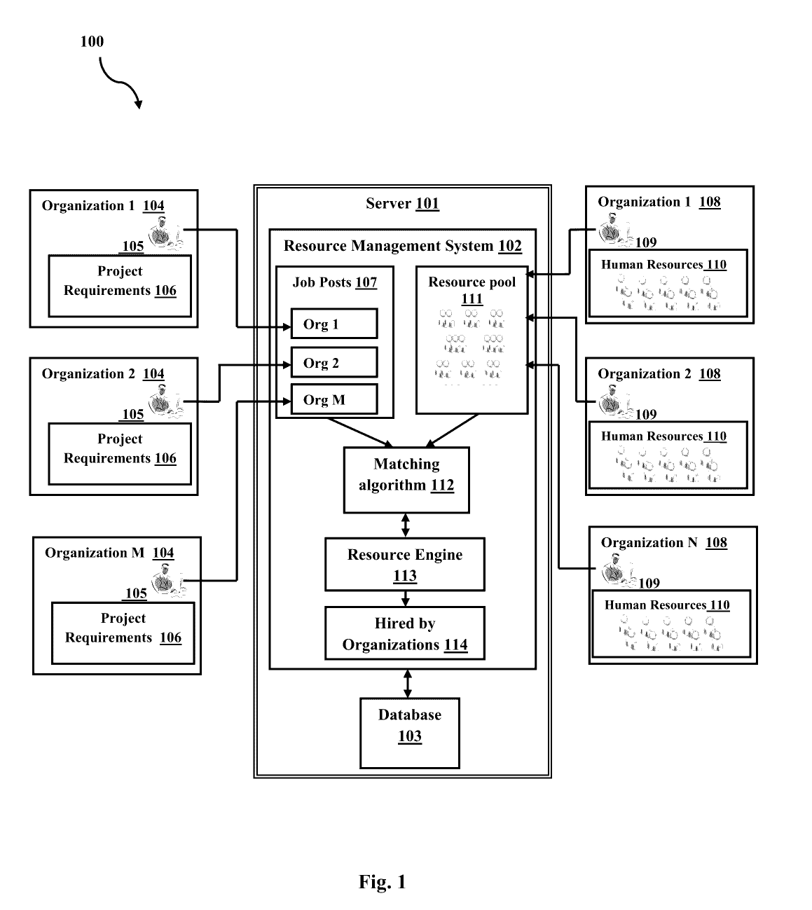

As mentioned above, there remains a need for a human resource management system and method. The embodiments herein achieve this by providing architecture for implementing a system and method of human resource management. The human resource management system includes a resource engine to facilitate the EMP organization to hire the hiring non-utilized human resources [herein referred as candidates] of human resource provider [herein referred as HRP] organizations who are available for short term projects of the employer's organizations [herein referred as EMP organizations]. Referring now to drawings, and more particularly to FIGS. 1 through 4, where similar reference characters denote corresponding features consistently throughout the figures, there are shown preferred embodiments. As used herein, the term “and/or,” when used in a list of two or more items, means that any one of the listed items can be employed by itself, or any combination of two or more of the listed items can be employed.

In some example embodiments, method and system for human resource management can be utilized for hiring candidates of HRP organizations who are available for short term projects of the EMP organizations and also the matching the skills of the candidates with the project requirement/job posting entered by EMP organizations, in which resource team of the HRP organization can enter and update the candidates profile including their skill and availability (from & period) in the system and the employer organization can view, sort, search, display the candidates profile based on the candidates profile parameters.

In some example embodiments, method and system for transparent recruitment can be utilized to allow the EMP organization to send the interview schedules for different round to the candidates of HRP organization. Further, the system and method can be utilized for receiving the details of interview schedule by HRP organization, and manage & monitor within the system. In addition, the system and method do not allow disclosing the personal & employment details of the candidate to the EMP organization.

In some example embodiments, method and system for human resource management can be utilized to allow the candidate to deploy with the EMP organization as a short term employee or contract employee, once the EMP organization confirms the candidate after the whole recruitment process. Further, the HRP organization can manage the calendar of the candidates outsourced using the system.

FIG. 1 illustrates a sample network environment 100 for implementing system and method of human resource management, according to an embodiment of the present invention. As shown in FIG. 1, the network environment 100 may include a server 101, a database 103, a network, an interface device (not shown), wherein the server 101 includes a resource management system 102. The server can be configured to run one or more application and connected and communicated to the database. The resource management system may include a matching algorithm 112 and recruitment engine 113. The network can comprise a plurality of data processing nodes interconnected for the purpose of data communication. Other components of the network environment can utilize the network to receive, transmit, and store data as well as for the purpose of accessing remote resources. The resource team 105 of the EMP organization 104 and the resource team 109 of the HRP organization 108 can access the resource management system using the interface device.

The database 103 may be utilized to store data processed by the resource engine 113. In some example embodiments, the data stored in the database 103 can originate in transactions external to the resource engine 113. The database 103 can also store data/information related to candidates' profile of the HRP organization 108 including skills & availability and job posting 107 of the EMP organization 104. The interface device (not shown) can be included in various interface devices including portals to facilitate transmitting and receiving data over the network. The interface device can permit the resource team 109 of HRP organization 108 and resource team 105 of EMP organization 104 to interact with the human resource management system 102 and/or resource engine 113.

The representation of the interface device in the form of a computing system or handheld computing system, within which a set of instructions for causing the device to perform any one or more of the methods described herein may be executed. In various example embodiments, the device operates as a standalone device or may be connected (e.g., networked) to other devices. In a networked deployment, the device may operate in the capacity of a server or a client device in a server-client network environment, or as a peer device in a peer-to-peer (or distributed) network environment. The interface device can include but not limited to mobile telephone, tablet, laptop, personal digital assistant (PDA), smart phone, a web appliance, or any device capable of executing a set of instructions (sequential or otherwise) that specify actions to be taken by that device. Further, while only a single device is illustrated, the term “device” shall also be taken to include any collection of devices that individually or jointly execute a set (or multiple sets) of instructions to perform any one or more of the methods discussed herein.

The exemplary interface device can include a processor or multiple processors (e.g., a central processing unit (CPU), a graphics processing unit (GPU), or both), a main memory, and a static memory, which communicate with each other via a bus. The interface device may further include a display unit (e.g., a liquid crystal display (LCD)). The interface device may also include an alphanumeric input device (e.g., a keyboard), an image capturing device (e.g. camera), a cursor control device (e.g., a mouse), a signal generation device (e.g., a speaker, mic) and a network interface device.

The resource engine 113 can be utilized to process of registration, candidate profile listing, job positing, matching profile, candidates' internal recruitment progress, deployment of candidates in EMP organization 104, managing the calendar of the candidates outsourced and among others. The instructions or commands may further be transmitted or received over a network via the interface device utilizing any of the transfer protocols (e.g., Hyper Text Transfer Protocol (HTTP). The example embodiments described herein may be implemented in an operating environment comprising software installed on the interface device, in hardware, or in a combination of software and hardware.

In accordance with an embodiment, the resource team 105 of EMP organization 104 can register on the system 102 to post/list the job 107 short term availability in their organization along with the required profile of candidates. The resource team 105 can handle, interact, view, sort, and display the candidates profile including the skills & availability using an interface device. The interface device enables the resource team 105 of EMP organization 104 to interact with the human resource management system 102 and/or resource engine 113.

In accordance with an embodiment, the resource team 109 of HRP organization 108 can register on the system 102 to provide the candidates/resource pool profile 111 including the skills and availability, and can have option to display the profile in public or private. Based on the available candidates' profile 111 and available job 107, the matching algorithm 112 can segregate the desired candidate profile to the EMP organization. Based on the matching profile, the recruitment engine 113 may send notification to the EMP organization 104 as well as the HRP organization 108 without disclosing the personal & employment details of the candidate to the EMP organization 104. Thereafter, the candidates' goes through the various stages of internal recruitment process such as written test, interview, group discussion, reference and checks, follow-up after interview, salary negotiation and signing of contract. After selection of the candidates, the candidates are hired 114 by EMP organization 104. In accordance with an embodiment, the resource engine 113 is configured for hiring non-utilized candidates of HRP organizations 108 who are available for short term projects of the EMP organizations 104.

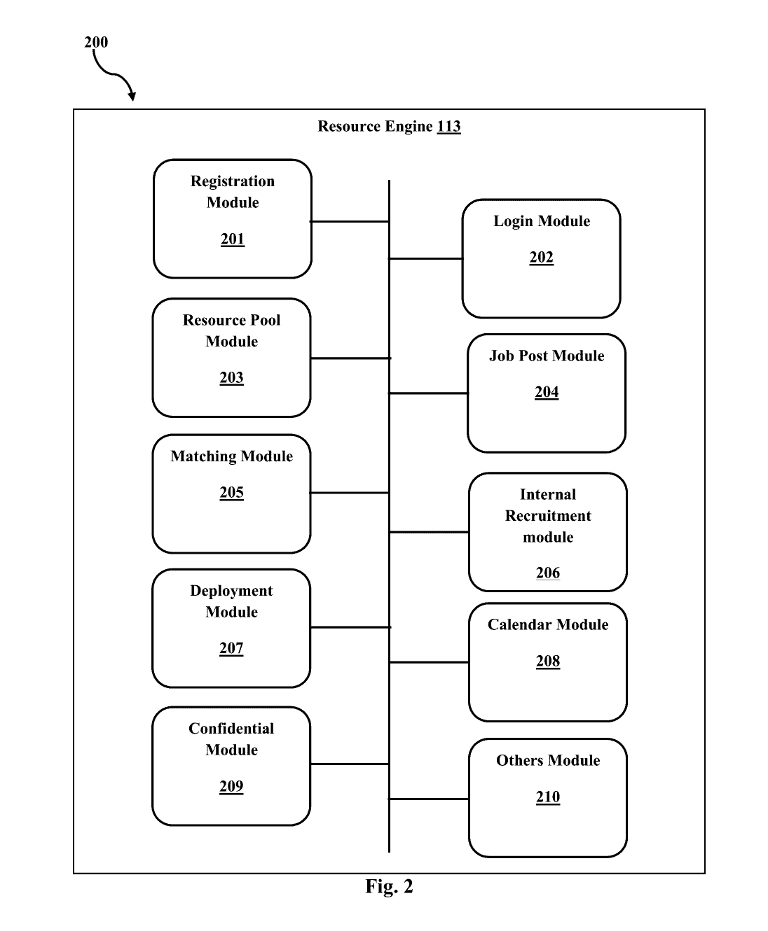

FIG. 2 illustrates a schematic diagram 200 of resource engine 113 of the human resource management system, according to an embodiment. The resource engine 113 may include a registration module 201, a login module 202, a resource pool module 203, a job post module 204, a matching module 205, an internal recruitment module 206, a deployment module 207, a calender module 208, a confidential module 209 and other modules 210.

In accordance with an embodiment, the registration module 201 can be configured to register the resource pool 111 of HRP organization 108 along with their mandatory information which can include, for example, name, skills and availability. Further, the registration module 201 can be configured to register EMP organization 104 along with their mandatory information which can include, for example, employer name, address, location and among others. All the mandatory information may not be made available to the public.

In accordance with an embodiment, the login module 202 can be configured to access the system 102 only with valid registered EMP organization 104 and/or HRP organization 108 in order to view, sort, display and search the candidates profile and/or job posting.

In accordance with an embodiment, the resource pool module 203 can be configured to allow the resource team 109 of HRP organization 108 to enter, store, and display with option for the candidates' profile including but not limited to name, skills and availability duration, wherein the display option can be made public or private to the registered EMP organization 104.

In accordance with an embodiment, the job posting module 204 can be configured to allow the resource team 105 of EMP organization 104 to enter, store and display with option for job positing details which can include, for example employer name, job title, salary offer, number of position, location, required short term timeline and so on, wherein the display option can be made public or private to the registered candidates.

In accordance with an embodiment, the matching module 205 can be configured to match the candidates profile along with job positing of EMP organization 104 and can segregate the candidates profile based on the nature of job posting and can be stored in the database 103 in a segregated manner, so that the resource team 105 of EMP organization 104 can easily view, sort the required candidates profile.

In accordance with an embodiment, the internal recruitment module 206 can be configured to allow the EMP organization to send the interview schedules for different round to the candidates., thus can facilitate the EMP organization can track the various stages of the candidate's recruitment and store the same in the database 103. Further, the internal recruitment module 206 can be configured for receiving the details of interview schedule by HRP organization 108, and manage & monitor within the system 102.

In accordance with an embodiment, the deployment module 207 can be configured to allow the candidate to deploy with the EMP organization as a short term employee or contract employee, once the EMP organization confirms the candidate after the whole internal recruitment process. In an embodiment, the negotiation and salary agreement may be done between EMP organization and HRP organization. The candidates may not aware of the payment done by EMP organization to HRP organization for the short term assignment of EMP organization. The resource team [109] of HRP organization [108] may take the decision of accepting or rejecting the placement offer.

In accordance with an embodiment, the calendar module 208 can be configured to allow the HRP organization 108 to manage the calendar of the candidates outsourced to the EMP organizations 104.

In accordance with an embodiment, the confidential module 209 can be configured for not allowing disclosing the personal & employment details of the candidate to the EMP organization 104.

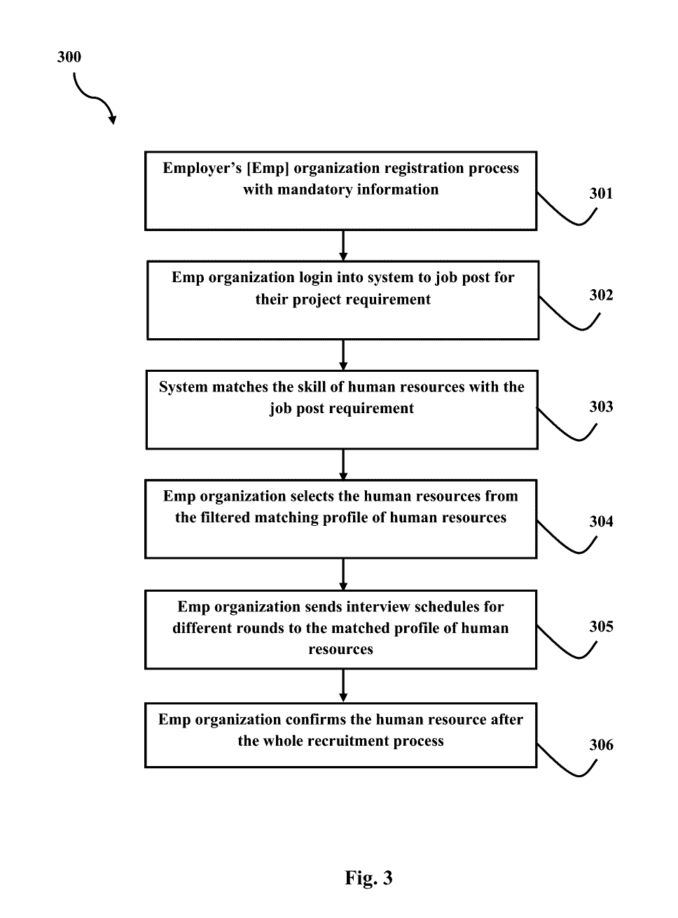

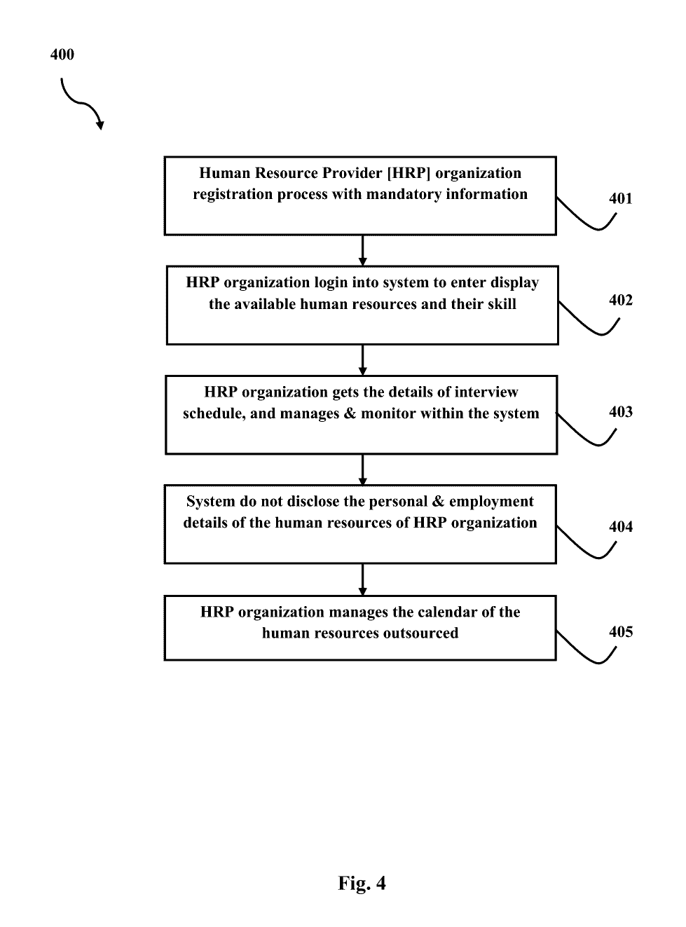

Exemplary methods for implementing system of providing transparent recruitment are described with reference to FIG. 3 to FIG. 4. The methods are illustrated as a collection of operations in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be deleted from the methods without departing from the spirit and scope of the subject matter described herein. In the context of software, the operations represent computer instructions that, when executed by one or more processors, perform the recited operations.

FIG. 3 illustrates role 300 of EMP organization 104 in the human resource management system and method, according to an embodiment. At block 301, the resource team 105 of EMP organization 104 may register the name along with their mandatory information which can include, for example, employer name, job title, salary offer, number of position, location, required short term contract and so on.

At block 302, the resource team 105 of EMP organization 104 may login into the system to job post for their project requirements which can include, for example, employer name, job title, salary offer, number of position, location, required timeline and so on.

At block 303, the system may match the candidates profile along with job positing of EMP organization 104 and can segregate the candidates profile based on the nature of job posting and can be stored in the database 103 in a segregated manner, so that the resource team 105 of EMP organization 104 can easily view, sort the required candidates profile.

At block 304, the EMP organization 104 may select the required profile of candidates from the filtered matching profile of candidates. The system may not disclose the personal & employment details of the candidate to the EMP organization 104

At block 305, the system may allow the EMP organization 104 to send the interview schedules for different round to the candidates of HRP organization 108.

At block 306, EMP organization 104 may confirm the candidates after the whole internal recruitment process.

FIG. 4 illustrates role 400 of HRP organization 108 in the human resource management system and method, according to an embodiment. At block 401, the resource team 109 of HRP organization 108 may register along with their mandatory information which can include, for example, candidates pool profile, availability, and skill of candidates.

At block 402, the resource team 109 of HRP organization 108 may login into the system to enter and display the available human resources and their skill

At block 403, the HRP organization 108 may get the details of interview schedule arranged by EMP organization 104, and also may manage & monitor within the system.

At block 404, the system may not disclose the personal & employment details of the human resources of the HRP organization 108.

At block 404, the HRP organization 108 may manage the calendar of the human resources outsourced to the EMP organization 104.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for transparent recruitment comprising
a server, a database, a network, and an interface device, wherein the server is connected and communicated with the database and includes a resource engine, wherein the resource engine includes
a registration module configured to register HRP organization along with their mandatory information and to register EMP organization along with their mandatory information;
a login module configured to access the system only with valid registered HRP organization and/or EMP organization;
a resource pool module configured to allow resource team of the HRP organization to enter, store, and display for the candidates' profile;
a job post module configured to allow the EMP organization to enter, store and display for job posting details,
a matching module configured to match the candidates profile along with job posting of EMP organization and segregate the candidates profile based on the nature of job posting;
the internal recruitment module configured to allow the EMP organization to send the interview schedules for different round to the candidates, and to receive the details of interview schedule by HRP organization, and manage & monitor within the system; and
the deployment module configured to allow the candidate to deploy with the EMP organization as a short term employee or contract employee, once the EMP organization confirms the candidate after the whole internal recruitment process.

2. The system as claimed in claim 1, wherein the resource engine further comprises of a calendar module configured to allow the HRP organization to manage the calendar of the candidates outsourced to the EMP organizations.

3. The system as claimed in claim 1, resource engine further comprises of a confidential module configured for not allowing disclosing the personal & employment details of the candidates to the EMP organization.

4. The system as claimed in claim 1, wherein the candidate profile includes candidate name, skill, availability duration.

5. The system as claimed in claim 1, wherein the job posting details includes employer name, job title, salary offer, number of position, location, and desired short term timeline.

6. A method for human resource management, wherein the method comprising allowing to register the HRP organization with their mandatory information which includes userid and candidates profile;
allowing to register the EMP organization with their mandatory information which includes employer name, address and location;
allowing the resource team of HRP organization to login into the system to access the job positing details of the EMP organization;
allowing the EMP organization to send the interview schedules for different round to the candidates, and to receive the details of interview schedule by HRP organization, and manage & monitor within the system; and
allowing the candidate to deploy with the EMP organization as a short term employee or contract employee, once the EMP organization confirms the candidate after the whole internal recruitment process.

7. The method as claimed in claim 6, wherein the method further comprising allowing the HRP organization to manage the calendar of the candidates outsourced to the EMP organizations.

8. The method as claimed in claim 6, wherein the method further comprising not allowing disclosing the personal & employment details of the candidates to the EMP organization.
